(19) United States
(12) Patent Application Publication
(10) Pub. No.: US 2014/0278455 A1
(43) Pub. Date: Sep. 18, 2014

(54) Providing Feedback Pertaining to Communication Style

(71) Applicant: MICROSOFT CORPORATION, Redmond, WA (US)

(72) Inventors: Nirupama Chandrasekaran, Seattle, WA (US); Mary P. Czerwinski, Kirkland, WA (US); Andrea L. Hartzler, Burien, WA (US); Rupa A. Patel, Seattle, WA (US); Wanda M. Pratt, Seattle, WA (US); Asta J. Roseway, Bellevue, WA (US)

(73) Assignee: MICROSOFT CORPORATION, Redmond, WA (US)

(21) Appl. No.: 13/803,164

(22) Filed: Mar. 14, 2013

(51) Int. Cl. G06Q 30/02; G06Q 50/22

(52) U.S. Cl. CPC G06Q 30/0203; G06Q 50/22
USPC 705/2

(57) ABSTRACT

An approach is described herein for providing feedback to the participants of a communication session. The approach entails automatically collecting cue information that characterizes, at least in part, the communication behavior that is exhibited during the communication session. The approach then generates signal information based on the cue information. In one case, the signal information conveys the empathy that is exhibited during the communication session. In one case, the signal information may have an affiliation dimension and a control dimension. Any participant can use the signal information during and/or after the communication session to gain awareness of his or her communication style, and to potentially modify his or behavior in response thereto.

### BACKGROUND

A caregiver who fails to exhibit sufficient empathy in dealing with a patient may negatively affect the course of that patient's treatment. (A caregiver, as the term is used herein, refers to anyone who provides health-related assistance of any kind to another person, either in a formal or informal setting; a caregiver, for instance, may correspond to a doctor, nurse, family member, etc.) Empathy, however, is a complex phenomenon; hence, neither the patient nor the caregiver may be able to fully identify those factors which are contributing to an unsatisfactory (or satisfactory) communication experience.

A caregiving environment may use various strategies to help caregivers improve their empathy. For example, a caregiving environment may provide training in a classroom setting regarding this topic. That training may encourage a caregiver to act in a certain way. But the caregiver may have difficulty transferring instructions received in a classroom setting to the caregiving environment, such as a clinical setting.

Further, clinical experience does not necessarily, by itself, rectify empathy-related shortcomings. Students, residents, and other junior caregivers do in fact learn empathy-related skills by observing the interaction styles of more senior caregivers. However, research shows that the empathy of students may also decline as training progresses. In addition, a seasoned doctor may find that his or her emotional sensitivity has been blunted over the years through repeated exposure to serious illness and trauma. As a result, the communication style of this doctor may convey a general sense of callousness to the patient.

Other environments (besides healthcare-related environments) may face similar challenges to those noted above. Generally stated, the outcome of a communication session depends in subtle ways on the communication styles exhibited during that session. Yet the participants may lack sufficient awareness of the factors that promote and impede successful communication. The participants may therefore have difficulty in improving their communication styles.

### SUMMARY

A cue processing system (CPS) is described herein for proving feedback to one or more participants of a communication session. In operation, the CPS collects cue information that characterizes, at least in part, the communication behavior that is exhibited during the communication session, including verbal and/or nonverbal communication behavior. The CPS then generates signal information based on the cue information. In one case, the signal information characterizes the empathy that is exhibited during the communication session. Any participant can use the signal information to gain awareness of the communication styles used in the communication session. A participant may then decide to modify his or her behavior in response to the signal information.

In one implementation, the communication session takes place in a healthcare-related environment in which at least one of the participants is a caregiver (e.g., a clinician) and at least one of the participants is a patient. In this context, the caregiver can intermittently observe the signal information during the session to provide more empathetic interaction with his or her patients. But the approach is not limited to healthcare-related environments; for example, it can be used in any counseling environment, any teaching environment, any business-related environment, etc.

Further, the approach can be used in situations in which two or more participants are communicating with each other using telecommunication equipment, from different respective locations. For example, the participants may be interacting with each other in the context of a social media system framework.

According to one illustrative implementation, the signal information comprises two or more dimensions, including: (a) an affiliation dimension which describes a degree to which one party attempts to reduce interpersonal distance with others, creating intimacy and immediacy during the communication session; and (b) a control dimension which describes a degree to which power is distributed among the participants of the communication session.

According to another illustrative aspect, the approach may formulate the signal information into interface information for presentation to one or more participants. In one case, the interface information may use a visual metaphor to describe empathy, such as, without limitation, a flower having multiple petals (or any other graphical object having component parts).

The above approach can be manifested in various types of systems, components, methods, computer readable storage media, data structures, articles of manufacture, graphical user interfaces, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative scenario in which two participants conduct a face-to-face communication session in a counseling context. A cue processing system (CPS) provides empathy-related feedback during the session.

FIG. 2 shows a scenario in which two or more participants communicate with each other using a telecommunication system. A CPS again provides empathy-related feedback during the session.

FIG. 3 provides an overview of the operation of the CPS that is used within the scenarios of FIGS. 1 and 2.

FIG. 4 shows one implementation of a CPS. The CPS maps cue information into signal information. The cue information, in turn, describes communication behavior, environmental factors, etc.

FIG. 5 shows a stand-alone implementation of the CPS of FIG. 4.

FIG. 6 shows a distributed implementation of the CPS of FIG. 4.

FIG. 7 shows interface information that conveys an affiliation dimension of the signal information produced by the CPS of FIG. 4.

FIG. 8 shows interface information that conveys a control dimension of the signal information produced by the CPS of FIG. 4.

FIG. 9 shows illustrative interface information that uses a flower metaphor to convey the affiliation and control dimensions of the signal information.

FIG. 10 is a flowchart that explains one manner of operation of the cue processing system of FIG. 4.

FIG. 11 shows illustrative computing functionality that can be used to implement any aspect of the features shown in the foregoing drawings.

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative user experience produced by a cue processing system. That experience provides feedback regarding communication behavior exhibited by participants of a communication session. Section B describes one implementation of the cue processing system. Section C describes illustrative interface information that can be produced by the cue processing system of Section B. Section D sets forth one manner of operation of the cue processing system of Section B. Section E describes illustrative computing functionality that can be used to implement any aspect of the features described in the foregoing sections. Section F sets forth illustrative cues that may be used to characterize the communication behavior of the participants.

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software, hardware (e.g., chip-implemented logic functionality), firmware, etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 11, to be described in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software, hardware (e.g., chip-implemented logic functionality), firmware, etc., and/or any combination thereof.

As to terminology, the phrase “configured to” encompasses any way that any kind of physical and tangible functionality can be constructed to perform an identified operation. The term “logic” encompasses any physical and tangible functionality for performing a task. For instance, each operation illustrated in the flowcharts corresponds to a logic component for performing that operation. When implemented by a computing system, a logic component represents an electrical component that is a physical part of the computing system, however implemented.

The phrase “means for” in the claims, if used, is intended to invoke the provisions of 35 U.S.C. §112, sixth paragraph. No other language, other than this specific phrase, is intended to invoke the provisions of that portion of the statute.

The following explanation may identify one or more features as “optional.” This type of statement is not to be interpreted as an exhaustive indication of features that may be considered optional; that is, other features can be considered as optional, although not expressly identified in the text. Finally, the terms “exemplary” or “illustrative” refer to one implementation among potentially many implementations

A. Illustrative User Experience

FIG. 1 shows an illustrative environment 102 in which two participants (104, 106) engage in a face-to-face communication session. A cue processing system (CPS) (not shown in FIG. 1) collects cue information regarding communication-related behavior exhibited by the participants during the communication session, and/or other factors affecting the communication session. The CPS maps the cue information into signal information. Without limitation, in one case, the signal information characterizes the empathy that is exhibited by the participants in the communication session. The CPS then forms interface information 108 that represents the signal information, and presents the interface information on an output device, such as a display device 110. The first participant 104 and/or the second participant 106 can observe the interface information 108 during the communication session. Based on this feedback, the first participant 104 and/or the second participant 106 can optionally adjust their communication style(s) to achieve one or more desired objectives. For example, the first participant 104 may attempt to modify her style of communication to increase her empathy in dealing with the second participant 106. The interface information 108 will subsequently reveal whether she is successful in her attempts.

At least one video camera 112 can produce video information that captures at least part of the body of the first participant 104. At least one other video camera (not shown) can produce video information which captures at least part of the body of the second participant 106. One or more microphones (not shown) can capture the voices of the first and second participants (104, 106). As will be described below, the environment 102 can include many other types of input devices (not shown in FIG. 1), such as the Kinect™ device (provided by Microsoft® Corporation of Redmond, Wash.), physiological sensors, etc. The Kinect™ device can be used to capture the posture and/or movements of participants in three-dimensional space.

In one implementation, the CPS system provides the interface information 108 for the principal consumption of one of the participants, such as the first participant 104. In that case, the first participant 104 (e.g., a doctor) may choose to place the display device 110 at any location in the environment 102 that is visible to her when interacting with the second participant 106. For example, in the case of FIG. 1, the first participant 104 has placed the display device 110 such that it lies behind the second participant 106, to one side of the second participant 106. This (merely illustrative) placement allows the first participant 104 to intermittently observe the interface information 108 while also continuing to engage the second participant 106. In other cases, the CPS can output interface information to two or more display devices provided at different locations in the environment 102. Any such display device can be observable by the first participant 104 (but not the second participant 106), or the second participant 106 (but not the first participant 104), or by both the first participant 104 and the second participant 106. Alternatively, or in addition, the CPS can provide interface information to other output devices, such as printer devices, storage devices, speaker devices, tactile output devices (e.g., vibrating output devices), and so on, or any combination thereof.

To facilitate and simplify explanation, most of the examples presented herein will assume that the conversation involves only two participants, as in the example of FIG. 1. But the CPS can also be used to provide feedback in a setting that involves more than two participants, as in a classroom-type setting or a group discussion setting.

The CPS can collect and analyze any factor that has an impact on the communication session. Such a factor is referred to as a cue herein. For example, some cues capture aspects of verbal communication. Verbal communication pertains to communication using a system of symbols—in other words, by means of a natural language. Other cues capture aspects of nonverbal behavior exhibited by one or more participants during the communication session. Nonverbal communication refers to any other way (besides verbal communication) that two or more people may communicate. For example, a smile by a participant constitutes a cue. Other cues describe the environment in which communication takes place, and so on. In general, cue information refers to information which describes a cue. The cue information is gleaned from the input information provided by the various input devices (video cameras, microphones, etc.).

While the CPS can collect and analyze any type of cue described above, to facilitate and simplify the explanation, this disclosure emphasizes the case in which the CPS predominantly collects and analyzes nonverbal cues and environmental cues. The Appendix (in Section F) lists several examples of these kinds of cues.

As indicated in the Appendix, some cues are non-relational in nature, e.g., in that they refer to behavior that is performed by a single person without reference to another person. For example, some cues may correspond to the movement or posture of an individual person, independent of the movement or posture of another person. Other cues refer to the manner in which a person speaks, such as that person's rate of speech, pitch of speech, loudness of speech, etc., independent of the speech of another person. Other cues refer to nonverbal sounds made by a person, such as laughter, a sigh, etc. Note that these kinds of audible cues involve the use of the voice; but this behavior does not constitute verbal communication because the person is not using his or her voice to convey symbolic information through the use of language.

Other cues are relational in nature because they refer to behavior of one person in relation to another person. For example, one relational cue may indicate that a participant has interrupted the speech of another person. Another relational cue may indicate that a participant is leaning towards another person, or hovering above another participant, and so on.

Some cues correspond to a single activity and/or state, while other cues correspond to a combination of activities and/or states. For example, one single-type nonverbal cue indicates that a person is speaking with a loud voice. One nonverbal combined-type cue may indicate that a person is speaking with a loud voice while wildly gesticulating with his or her hands. Another combined-type cue may correspond to the combination of one or more nonverbal cues with one or more cues selected from another category of cues, such as one or more verbal cues, one or more environmental cues, etc.

Some cues are agnostic with respect to the identity of the participant(s) who are performing the behaviors associated with the cue. For example, one participant-agnostic cue may indicate whether a participant is smiling, without regard to whether the participant is a caregiver or a patient. Other cues depend on the identity(ies) of the participant(s) who are performing the behaviors associated with the cue. For example, one participant-specific cue may indicate that a caregiver is leaning towards a patient.

As noted above, the CPS can also collect cues which pertain to the environment in which communication takes place. These constitute environmental cues. For example, some cues may correspond to the physiological state of one or more participants, such as a person's breathing rate, heart rate, blood pressure, electrodermal activity, brain activity information, etc. Other cues may correspond to aspects of the physical setting in which the conversation takes place, such as the temperature of the setting, the ambient noise in the setting, odors in the setting, equipment in the setting, the presence of other people in the room, the formality of the setting, etc. Other cues may correspond to the context in which a communication session takes place, such as the time of day in which the session takes place. Another contextual cue can indicate whether the interaction has a task-related orientation, a social orientation, or some other orientation, or a combination thereof.

To repeat, the types of cues described above are mentioned above by way of illustration, not limitation. Different cues may be appropriate to different environments. Further, in any environment, the set of cues that are collected and examined by the CPS is fully configurable and extensible. That is, an administrator can configure the CPS so that it collects additional types of cues; in addition, or alternatively, an administrator can configure the CPS so that it no longer collects certain cues that it previously collected.

As noted above, the CPS can map the cues, whatever their nature, into a reflection of any high-level communication characteristic(s) that are exhibited by the communication session, such as, but not limited to, empathy. Empathy may be defined in different ways in different environments. In one context, the empathy of a first person towards a second person refers to the extent to which the first person can sense the mental state (thoughts, emotions, etc.) of a second person, without requiring the second person to provide an explicit verbal description of his or her mental state. More loosely stated, empathy refers to the emotional and/or cognitive attunement between two or more people, e.g., with respect to issues of wellbeing. For example, a teacher may be said to have an empathetic understanding of a student when the teacher can decode and communicate appreciation for the stresses and strains to which the student may be subjected.

Note that the CPS's empathy measure depends on the detectable manifestations of empathy during the communication session, as reflected by the above-described nonverbal cues and/or other factors. Hence, more precisely stated, the CPS can be said to provide a measure of empathy which focuses, at least in part, on the manner in which a first participant outwardly exhibits empathy with respect to another person, and/or vice versa. At the same time, the CPS can apply a set of cues that are selected in such a manner that a person's outward manifestation of empathy most likely matches that person's “inner” manifestation of empathy, e.g., as reflected in that person's thoughts and feelings. In some implementations, the CPS can also collect physiological cues (such as brain activity information) which may more directly correlate with a person's “inner” emotions and cognitive functions.

To repeat, empathy is just one example of high-level characterization of a person's communication style. More generally, the CPS can map the cues to any high-level characterization of the communication style(s) exhibited in a communication session. For example, alternatively, or in addition, the CPS can map the cues into a measure which reflects an amount of anxiety that is being exhibited in a communication session.

As a point of clarification, a person who observes the interface information 108 may be primarily interested in determining how his or her behavior is impacting the communication session, for better or worse. In one implementation, however, the CPS can form its empathy feedback based on the relational behavior of both the first and second participants (104, 106). Hence, in this implementation, the CPS can be said to provide feedback which characterizes the nonverbal nature of the conversation as the whole. In the empathy-related context, for instance, the CPS can provide information that indicates that the conversation as a whole is not conducive to an empathetic exchange among the participants. In other cases, the CPS may collect and analyze cues which are more strongly focused on the behavior exhibited by a single person in the communication session, such as a doctor who is providing care to a patient.

The signal information can be composed of one or more dimensions, also referred to herein as relational signals. For example, the signal information may include one or more of: (a) an affiliation dimension which describes a degree to which one party attempts to reduce interpersonal distance with others, creating intimacy and immediacy during the communication session; (b) a control dimension which describes a degree to which power is distributed among the participants of the communication session; (c) a composure dimension which describes a degree of anxiety that is exhibited during the communication session, versus calmness; (d) a formality dimension which describes a degree to which the interaction in the communication session is formal in nature, versus relaxed in nature; and (e) an orientation dimension which describes a degree to which the interaction in a communication session is task-directed in nature, versus social-oriented in nature, and so on.

For example, assume that the CPS system is dedicated to providing feedback to a clinician in a counseling environment, such as a healthcare-related environment. Empathy in that scenario can be treated as being principally composed of the affiliation and control dimensions. A clinician exhibits the highest empathy when he or she exhibits a high level of affiliation and a moderate level of control.

The dimensions referred to above are cited by way of example, not limitation. Other implementations can provide models which map the cue information into other dimensions, and/or may omit models which produce the types of dimensions mentioned above.

The CPS can be used in many different contexts. In the most prominent example featured herein, the CPS is used to provide empathy-related feedback in a healthcare-related context. In that setting, the first participant 104 may correspond to a caregiver (e.g., a clinician) while the second participant 106 may correspond to the person that is receiving care (e.g., a patient). For example, the clinician may correspond to a doctor, nurse, orderly, dentist, emergency care provider, and on. In one caregiving context, the environment 102 may correspond to an examination room, hospital room, or other setting in which a caregiver may interact with a patient.

The CPS can also be used in various “specialty” health-related environments. For example, the CPS can be used to provide feedback to parents or other caregivers in dealing with autistic or other special-needs children. In another case, the CPS can be used to provide feedback to hospice workers in dealing with terminally ill patients and their families. In another case, the CPS can be used to provide feedback to workers in a nursing homes in dealing with the elderly (who may have various forms of dementia), and their families. In another case, the CPS can be used to provide feedback to doctors and other health professional in oncology departments, who deal with patients who may be gravely ill.

The CPS can also be used to provide feedback in other counseling-related environments that are not necessarily related to healthcare. That is, the participant 104 may correspond to the counselor and the participant 106 may correspond to the person receiving counseling. For example, the CPS can be used in a legal counseling context, a marriage counseling context, a teacher-parent counseling context, a child counseling context, an addiction-counseling context, and so on.

The CPS can be also be used in various educational settings. For example, the CPS can be used to provide feedback in a classroom setting or an in-field setting. The recipients of the instruction can include a single student or plural students. An instructor (or any student) can glean various insights from the feedback provided by the CPS. For example, the feedback may indicate whether the instructor is being duly empathetic to the concerns raised by any student. Alternatively, or in addition, the feedback may indicate whether a particular student (or the instructor herself) is dominating the classroom discussion.

The CPS can also be used in various business-related contexts. For example, the CPS can be used to provide feedback to a person who works at a help desk. That feedback may indicate whether that person is providing an appropriate level of empathy in dealing with complaints that are presented to him or her. In another case, the CPS can be used in a sales context to provide feedback regarding the communication style being employed by a salesperson. In another case, the CPS can be used to assess the manner in which a supervisor interacts with a subordinate (or vice versa), or the manner in which two or more peers in the workplace interact with each other, or the manner in which an interviewee interacts with a prospective employer, and so on.

In each of the above-stated examples, the CPS provides feedback to two or more communication participants who are physically present in the same physical setting (e.g., the same room). In other cases, at least two participants of the communication session may be present in different physical settings. These two participants may use any equipment to communicate with each other, such as teleconferencing equipment.

Consider, for example, the environment 202 shown in FIG. 2. Here, the first participant 104 again converses with the second participant 106 in a face-to-face manner within a local setting, while observing the interface information 108 provided on a display device 110. In addition, the first participant 104 and the second participant 106 can communicate with a third participant who is present at another physical location (relative to the local setting). A video conferencing system (not shown) can present a visual depiction 204 of the third participant on a display device 206. That is, one or more video cameras and one or more microphones at the remote setting can capture the appearance and voice of the third participant for presentation to the first and second participants (104, 106), while one or more video cameras and one or more microphones at the local setting can capture the appearance and voice of the first and second participants (104, 106) for presentation to the third participant. In other cases, the video conferencing system can optionally also create a tele-immersive experience, which gives the participants the impression that they are physically present in the same communication space. For example, the video conferencing system can use tele-immersion techniques to allow remote participants to interact with virtual objects in a shared workspace.

In the particular situation of FIG. 2, the first participant 104 continues to receive feedback from the CPS via the display device 110, or some other local user device(s). Alternatively, or in addition, the CPS can provide the interface information on the same display device 206 with which the first participant 104 interacts with the third participant. For example, the CPS can display interface information in a section 208 of the display device 206. Likewise, the CPS can provide interface information for consumption by the third participant at the remote setting, e.g., via a remote counterpart to the display device 110 and/or the section 208.

The case in which two local participants communicate with a single remote participant is merely illustrative. More generally, one or more local participants can communicate with any number of remote participants using any kind of video conference technology, such as, without limitation, the Skype™ video conferencing system provided by Microsoft® Corporation of Redmond, Wash. For example, the CPS can provide feedback to just two remotely-separated participants. Each participant may interact with local teleconferencing equipment and monitor local interface information during the course of the conversation.

In other cases, two or more physically-separated participants can communicate with each other in the context of some system framework, such as a social networking framework (e.g., the Facebook system provided by Facebook, Inc. of Menlo Park, Calif.), an online dating framework, a gaming system framework, a shopping-related framework, a telemedicine framework (in which patients remotely interact with their caregivers), and so on. Further, applications running on the above-described kinds of systems can leverage the relational signals produced by the CPS in any manner.

FIG. 3 summarizes the operation of the CPS in the scenarios of FIGS. 1 and 2. In a first operation, the participants exhibit verbal and/or nonverbal behavior in the course of a communication session. In a second operation, the CPS collects cue information that characterizes the verbal and/or nonverbal communication, optionally together with cue information that characterizes the environment in which the communication takes place. FIG. 3 depicts each instance of the cue information as CUEᵢ. In a third operation, the CPS maps the cue information into signal information. FIG. 3 depicts each dimension of the signal information as RSⱼ, also referred to as a relational signal. In a fourth operation, the CPS presents interface information that represents the signal information.

In a fifth operation, one or more participants observe the interface information. One or more participants may then optionally change their behavior based on this information. For example, the first participant 104 may determine that she is being too domineering in the communication session; this may prompt her to subsequently grant the second participant 106 more speaking time. Based on updated instances of the interface information 108, the first participant 104 can determine whether this modified behavior produces the desired effect.

B. Illustrative Cue Processing System

FIG. 4 shows one implementation of a cue processing system (CPS) 402 that provides the type of user experience described in Section A. The CPS 402 includes a collection of input devices 404 for receiving cue information from two or more participants 406. As noted above, the cue information corresponds to a variety of cues. Each cue corresponds to a particular type of verbal and/or nonverbal communication and/or an environmental factor. However, this section will describe the CPS 402 in the illustrative context in which most of the cues correspond to nonverbal behavior exhibited by the communication participants; in connection therewith, Section F sets forth a non-limiting and extensible list of possible nonverbal and environmental cues.

The input devices 404 can correspond to any equipment for capturing any of: the behavior of the participants; environmental information pertaining to the physiological states of the participants; environmental information pertaining to the physical setting and context in which the communication session takes place, and so on. Without limitation, the input devices 404 can include one or more video cameras, one or more microphones, one or more depth-determination devices, one or more physiological sensors, and so on. Each video camera can produce a video image by sensing radiation in any portion of the electromagnetic spectrum, including the visible spectrum, the infrared spectrum, and so on. Each depth-determination device can produce a depth image using any depth-determination technique, such as a structured light technique, a time-of-flight technique, a stereoscopic technique, so on. Each point in a depth image reflects the distance between a reference point and a location in the scene containing the participants 406. Depth-analysis functionality can then use the depth image to produce a three-dimensional representation of the scene, including the participants 406 in the scene. In one embodiment, each depth-determination device can be implemented using the Kinect™ device.

The input devices 404 can also include input mechanisms with which a user may manually interact. For example, a user (e.g., an administrator, a participant, etc.) may use a keypad device to enter information which describes the room in which the communication session takes place, the roles associated with the participants, the context in which the communication session is taking place, and so on. Alternatively, or in the addition, the CPS 402 can automatically infer this kind of information (e.g., by inferring that a particular participant is the caregiver based on the position of that participant within the room, etc.).

A cue analysis module 408 processes the cue information provided by the input devices. The cue analysis module 408, in turn, includes (or can be conceptualized as including) plural sub-modules that perform different respective functions, set forth below.

To begin with, a receipt module 410 receives the cue information. This description refers to the cue information, in its initial state, as raw cue information. The raw cue information may include any combination of video images, audio signals, depth images, physiological signals, etc.

A preprocessing module 412 processes the raw cue information to provide processed cue information. To perform this task, the preprocessing module 412 uses a collection of individual preprocessing modules (PPMs). Each PPM receives a subset of instances of raw cue information, and, based thereon, computes processed cue information associated with a particular cue.

One type of PPM generates cue information that describes the movement and/or posture of one or more participants. This kind of PPM may be referred to as a depth-analysis PPM. In one implementation, a depth-analysis PPM operates by receiving one or more depth images of the space in which the participants are interacting. The depth-analysis PPM then computes three-dimensional representations of each participant based on the depth images. In a Kinect™-related framework, the depth-analysis PPM can perform this task by forming a skeletonized representation of each participant, e.g., formed by a plurality of joints coupled together by line segments. The depth-analysis PPM can then compare the skeletonized representations of the participants against a predetermined pattern associated with whatever behavior that the depth-analysis PPM is configured to detect. The depth-analysis PPM can conclude that the behavior has been performed if the representations match the predetermined pattern.

Another type of PPM can employ image analysis without the use of depth images. This kind of PPM can be referred to as an image-analysis PPM. In one implementation, an image-analysis PPM can extract features from video information. The image-analysis PPM can then process the features using any image analysis technique, e.g., by comparing the features against a predetermined pattern associated with whatever behavior that the image-analysis PPM is configured to detect. For example, one such image-analysis PPM can use image analysis to track the gaze of each participant. Another image-analysis PPM can use image analysis to track the head movement of each participant. Another image-analysis PPM can use image analysis to recognize the facial expression of each participant, and so on.

Another type of PPM can apply audio analysis to form cue information. This kind of PPM can be referred to as an audio-analysis PPM. For example, one type of audio-analysis PPM can analyze any of the pitch, rate, volume, etc. of a speaker's voice to form cue information. Another type of audio-analysis PPM can compare the speech of a first participant to the speech of a second participant to form cue information. This kind of audio-analysis PPM can, for example, determine whether the first participant has interrupted the second participant, or vice versa. Another type of audio-analysis PPM can determine the amount of time that the first participant is speaking relative to one or more other participants. Another type of audio-analysis PPM can determine nonverbal sounds that participant makes, e.g., by sighing, or laughing, or uttering nonverbal sounds like “ah,” or “uh.” This kind of audio-analysis PPM can detect certain sounds using a conventional acoustic model that is trained to recognize those sounds.

Another kind of PPM can process one or more kinds of physiological signals. This kind of a PPM may be referred to as a physiological-analysis PPM. For example, one kind of physiological-analysis PPM can compare the breathing rate of a participant against a predetermined threshold to determine if it qualifies as “rapid.”

Some PPMs can also receive, as inputs, the outputs of one or more other PPMs. This type of PPM may be referred to as an aggregate-analysis PPM. For example, consider a cue that indicates that a first participant is speaking with a loud voice while standing over his conversation partner. A first audio-analysis PPM can determine whether the first participant is speaking with a loud voice. A second depth-analysis PPM can determine whether the first participant is standing over the other participant. A third aggregate-analysis PPM can receive the outputs of the audio-analysis PPM and the depth-analysis PPM to determine whether the first participant is both (1) standing over the second participant and (2) speaking in a loud voice.

The preprocessing module 412 can include yet other types of PPMs. The types of PPMs mentioned above are cited by way of example, not limitation. In any case, the cue information provided by all of the individual PPMs constitutes a feature vector. That is, each dimension of the feature vector constitutes an instance of cue information associated with a particular cue. For example, the feature vector will have 200 dimensions if the cue analysis module 408 is configured to detect the presence or absence of 200 cues.

A signal determination module 414 maps the feature vector into signal information. The signal determination module 414 can perform this task in various ways. In one approach, the signal determination module 414 includes a plurality of models. Each model may receive the feature vector. The model maps the feature vector to an output value that corresponds to a particular dimension of the signal information.

For example, from a high-level perspective, the signal determination module 414 may produce signal information that represents the empathy in a communication session. As noted, empathy can be conceptualized as including an affiliation dimension and a control dimension. A first model can map the feature vector into an output value pertaining to the affiliation dimension. A second model can map the feature vector into an output value pertaining to the control dimension. In other implementations, the signal determination module 414 can include models that provide output values associated with composure, formality, and orientation, as described above. Depending on the model, a model's output value may correspond to a binary yes/no-type output, a discrete-valued output (where the output is selected from a set of values including more than two possible values), a continuous range value, etc.

In one approach, a model can be produced using a machine learning technique, e.g., by statistically analyzing a training corpus of examples. That is, the training corpus includes a plurality of training examples, where each training example maps a feature vector into an established interpretation of the communication style(s) associated with that feature vector. This kind of model may take the form of weighting parameters associated with the various dimensions of the feature vector. In other implementations, a model can be implemented using an artificial intelligence engine, an expert system engine, a neural network engine, a deterministic lookup table and/or algorithm, and so on.

The CPS 402 can also optionally collect additional training data through the use of the CPS 402. For example, the CPS 402 can ask participants to provide assessments of their communication sessions. The signal determination module 414 can use those kinds of evaluations, together with cue information collected during the communication sessions, to improve the performance of the model(s). This option may be most effective in an online implementation, e.g., in which participants communicate with each other via teleconferencing equipment.

An interface generation module 416 receives the signal information from the signal determination module 414. The interface generation module 416 then transforms the signal information into interface information, which represents the signal information. The interface generation module 416 then sends the interface information to one or more output devices 418. Illustrative output devices 418 include LCD displays, stereoscopic displays, printers, tactile output devices (e.g., devices which vibrate, etc.), audio output devices, and so on, or any combination thereof. Alternatively, or in addition, the interface generation module 416 can modulate the lighting in a room (and/or any other environmental condition in the room, such as background music, etc.) based on the interface information.

Section C (below) will provide further details regarding different ways in which the interface generation module 416 can express the signal information as interface information. By way of preview, in one example, the interface generation module 416 can produce interface information in the form of a chart of any nature, a visual metaphor of any nature, etc. The interface generation module 416 can then send that interface information to a display device, such as the display device 110 of FIGS. 1 and 2.

An archival module 420 can also store any information processed and/or produced by the cue analysis module 408, including raw cue information, processed cue information, and/or signal information. The archival module 420 can also store the interface information produced by the interface generation module 416. The archival module 420 can also store metadata associated with each communication session, including demographic information regarding the participants of each communication session, treatment information, etc., all of which can be properly sanitized to omit or obscure sensitive data pertaining to the participants.

The archival module 420 can also include search and retrieval tools for retrieving any subset of the information that is stored in the data store 422. For example, a participant (or any other user) can specify a starting date and an ending date. The archival module 420 can then retrieve information regarding the empathy exhibited by the participant over the course of the designated timeframe. This information gives the participant insight into trends in his or her communication style over an extended period of time. The participant can leverage this insight by changing his or her communication style to address identified shortcomings

The archival module 420 can also incorporate data mining tools. A researcher (or any other user) can use the data mining tools to perform any kind of data mining based on information stored in the data store 422, leveraging, for instance, the metadata stored in the data store 422. For example, if duly authorized, a user can investigate how empathy varies (or any other communication trait) within a healthcare-related environment with respect to various factors, such as the experience of the caregivers, the age of the patients, the gender of the patients, the ailments of the patients, and so on; the data mining possibilities in this regard are vast. The archival module 420 can also work in conjunction with the interface generation module 416 to represent the data retrieved from the data store 422 in various selectable formats, such as various charts, various visual metaphors, etc.

A configuration module 424 allows a user to configure any aspect of the CPS 402. The user may correspond to an administrator, a participant, etc. For example, the user can use the configuration module 424 to select the input devices 404 that are used to supply raw cue information to the cue analysis module 408. In addition, or alternatively, a user can use the configuration module 424 select the output device(s) that will receive the interface information generated by the cue analysis module 408. In addition, or alternatively, the configuration module 424 can configure the preprocessing module 412 to look for particular kinds of cues. In addition, or alternatively, the configuration module 424 can configure the signal determination module 414 to map the cues into particular dimensions of signal information. In addition, or alternatively, the configuration module 424 can configure the interface generation module 416 to formulate the signal information into a particular type of interface presentation.

As a final point with respect to FIG. 4, this figure indicates that, in one implementation, the cue analysis module 408 forms signal information based mainly on the nonverbal communication that is exhibited by the communication participants, and optionally various environmental factors associated with the setting in which the communication takes place. In another implementation, the cue analysis module 408 can also take into account any aspect of the verbal communication that takes place between the participants. For example, the preprocessing module 412 can include one or more PPMs that recognize words that the participants have spoken; further, the signal determination module 414 can use one or more linguistic models which map the recognized words into signal information. For instance, a model may reveal that certain linguistic practices negatively impact the perceived empathy of a doctor, such as the doctor's use of technical jargon, the doctor's failure to address the patient by name, the doctor's frequent use of negative words, etc.

FIG. 5 shows a local implementation of the CPS 402 of FIG. 4. Here, local computing functionality 502 implements all aspects of the CPS 402. FIG. 5 makes this point by indicating that the local computing functionality 502 includes CPS functionality 504, which represents all aspects of the CPS 402. The local computing functionality 502 can be implemented using one or more computer devices, such as one or more personal computers, computer workstations, laptop computers, game console devices, set-top box devices, tablet-type devices, smartphones or the like, etc.

FIG. 6 shows a distributed implementation of the CPS 402 of FIG. 4. The distributed implementation includes plural instances 602 of local computing functionality, including representative local computing functionality 604. The instances 602 of the local computing functionality may interact with remote computing functionality 606 via a communication mechanism 608. Each instance of local computing functionality can be implemented in the same manner described above for FIG. 5. The remote computing functionality 606 may be implemented by one or more servers and associated data stores, providing at a single location or distributed over plural locations. The communication mechanism 608 may correspond to any network, such as a local area network, a wide area network, point-to-point connections, etc.

The functionality of FIG. 6 also includes a video conferencing system 610. At least two participants of the communication session may interact with each other using the video conferencing system 610, using their respective instances of local computing functionality. The users may also interact with the video conferencing system 610 in the context of any other system 612, such as a social networking system, etc.

FIG. 6 indicates that the functionality associated with the CPS 402 can be distributed between the instances 602 of computing functionality 604 and the remote computing functionality 606 in any manner. FIG. 6 makes this point by showing that the representative local computing functionality 604 includes local CPS functionality 614, while the remote computing functionality 606 provides remote CPS functionality 616. For example, in one case, the remote computing functionality 606 may implement all aspects of the cue analysis module 408 and/or the interface generation module 416, etc. In another case, each instance of local computing functionality can perform some aspects of the cue analysis module 408 and/or the interface generation module 416, etc. The remote CPS functionality 616 can be implemented, for example, as online functionality which provides backend services to each instance of local computing functionality, e.g., using cloud computing resources.

FIG. 6 also indicates that the video conferencing system 610 corresponds to functionality that can be distributed between individual instances 602 of local computing functionality. For example, each local participant's instance of local computing functionality can store software which allows the participant to communicate with remote participants. In another implementation, the remote computing functionality 606 can also implement aspects of the video conferencing system 610.

C. Illustrative Interface Information

This section provides additional illustrative details regarding the operation of the interface generation module 416. As stated above, the signal determination module 414 maps the processed cue information into signal information. The signal information may include one or more dimensions. The interface generation module 416 transforms the signal information into interface information. The interface information represents the signal information in a format that can be consumed by one or more participants of the communication session.

More specifically, the interface generation module 416 can produce interface information having multiple different aspects, referred to herein as components. For example, the interface generation module 416 can produce an interface component that represents each dimension of the signal information.

In one case, the interface generation module 416 can produce independent interface components associated with the respective dimensions. An output device may provide these interface components as separate and independent presentations. In another case, the interface generation module 416 can produce a top-level interface component that includes one or more sub-components. Each sub-component may corresponds to a different dimension of the signal information. An output device may present the top-level interface component as a single presentation, which encompasses information pertaining to one or more dimensions.

In some cases, the interface generation module 416 can produce interface information which represents a current state of the signal information. The interface generation module 416 can update the current state at any user-specified frequency, such as every n seconds (or fractions of a second), every n minutes, etc. In other cases, the interface generation module 416 can also present historical information. The historical information conveys one or more prior instances of signal information. For example, consider the case in which the CPS 402 updates the signal information every 60 seconds. The interface generation module 416 can provide an indication of the current instance of the signal information at time t, together with the last k instances of the signal information, e.g., at t−1 minutes, t−2 minutes, etc.

In some cases, the interface generation module 416 can produce interface information which reflects the communication session as a whole, without necessarily associating any information with any one participant. In other cases, the interface generation module 416 can produce interface information that has one or more user-specific components, in which each component conveys information that pertains to a particular participant.

The interface information itself can take any form. For example, the interface generation module 416 can formulate the interface information into numeric data, symbolic data, graphical data, audio data, tactile data, ambient lighting data, and so on, or any combination thereof. For the case in which interface information corresponds to numeric or symbolic data, etc., the interface generation module 416 can express the signal information in any form, such as a list, tabular data, etc. Similarly, for the case in which the interface information corresponds to graphical data, the interface generation module 416 can express the signal information in any chart form, such as bar charts, scatter plots, etc. Alternatively, or in addition, the interface generation module 416 can express the signal information using any visual metaphor.

With the above general introduction, FIGS. 7-9 show examples of graphical interface information that may be produced by the interface generation module 416. These instances of interface information are presented here by way of example, not limitation.

In these figures, assume that the signal information represents empathy, and that empathy, in turn, includes an affiliation dimension and a control dimension. As noted above, the affiliation dimension describes a degree to which one party attempts to reduce interpersonal distance with others, creating intimacy and immediacy during the communication session. The control dimension describes a degree to which power is distributed among the participants of the communication session. Assume that the communication session involves two participants, participant P₁ and participant P₂.

FIG. 7 shows an interface component that represents the affiliation dimension of empathy. This interface component corresponds to a ball having variable diameter and variable color. A large bright ball represents a high affiliation score, generally associated with friendliness, warmth, and intimacy exhibited by a caregiver (for instance). A small darkish ball represents a low affiliation score, generally associated lack of the above-identified traits. For instance, in a state 702, the interface information presents a small dark ball 704. In a state 706, the interface information presents a large bright ball 708.

FIG. 8 shows an interface component that represents the control dimension of empathy. This interface component corresponds to a ball that rolls on a seesaw ramp. One side of the seesaw represents the first participant (P₁), while the other side represents the second participant (P₂). The seesaw and ball tilt to whatever participant is dominating the conversation, if any. For example, in state 802, the interface component indicates the first participant is dominating the conversation. In state 804, the interface component indicates that the second participant is dominating the conservation. If no party is dominating the conversation, the interface component presents a level seesaw, with the ball placed in the middle of the seesaw.

FIG. 9 shows interface information which uses a graphical object to convey the different dimensions of the signal information, based on a visual metaphor. In this non-limiting example, the graphical object corresponds to a flower having multiple petals. The petals on the left side correspond to the nonverbal behavior exhibited by the first participant. The petals on the right side correspond to the nonverbal behavior exhibited by the second participant.

More specifically, consider a particular petal. The size of the petal, relative to the counterpart petal on the opposite side (associated with the other participant), may indicate the degree of control that the participant is exercising during the communication session. A relatively large petal means the person is being relatively domineering in the conversation; a small petal means the person is being relatively submissive. The color of each petal reflects the affiliation exhibited by the participant. A bright color may indicate a high affiliation score, while a darker color may represent a lower affiliation score. A flower that has dark petals may correspond to an unfriendly, formal, and “cold” conversation.

In one implementation, the lower-most pair of petals in the flower represents the current instance of signal information for the first and second participants at time t. The next two petals (in the upward direction) represent the signal information at time t−1. The next two petals (in the upward direction) represent the signal information at time t−2, and so on. When a new petal is displayed, the interface generation module 416 can shift all of the existing pairs of petals in the upward direction. The interface generation module 416 can remove the top-most pair of petals corresponding to the oldest instance of signal information. Hence, the pairs of petals represent a visual FIFO stack, with the pair of petals on the bottom corresponding to the newest member of the stack, and the pair of petals on the top corresponding to the oldest member of the stack.

The flower metaphor shown in FIG. 9 can be modified in any number of ways. For example, the affiliation dimension of empathy can be mapped to a first visual attribute of each individual leaf (not necessarily the color of a leaf), while the control dimension of empathy can be mapped to a second visual attribute of an individual leaf (not necessarily the size of a leaf).

Further, the interface generation module 416 can use other visual metaphors besides the flower metaphor shown in FIG. 9. For instance, the interface generation module 416 can convey the same information shown in FIG. 9 by presenting any graphical object having pairs of components arrayed along any axis (where that axis represents time, and each member of a pair is associated with a particular participant). For example, the interface generation module 416 can convey the information shown in FIG. 9 by arranging pairs of bars or other shapes along a vertical or horizontal axis, instead of leafs. Other visual metaphors can provide information pertaining to the communication styles of more than three participants, e.g., by providing a three-dimensional counterpart to the flower metaphor shown in FIG. 9. Other visual metaphors can provide benchmarks to indicate whether a participant's behavior is achieving a desired goal. For example, a thermometer metaphor, bulls-eye metaphor, traffic light metaphor, etc. can convey this kind of benchmark-related information.

The interface generation module 416 can also produce interactive interface information. For example, the interface generation module 416 can include functionality that allows a user to “slice and dice” a multi-dimensional chart or graphical object to display certain selectable aspects of the interface information (e.g., pertaining to certain participants, certain dimensions of the relational signal information, certain time spans, etc.)

D. Illustrative Manner of Operation

FIG. 10 shows a procedure 1002 that explains one manner of operation of the cue processing system (CPS) 402 of FIG. 4. Since the principles underlying the operation of the CPS 402 have already been described in preceding sections, certain operations will be addressed in summary fashion in this section.

In block 1004, the CPS 402 collects raw cue information from any combination of input devices 404 described in Section B. In block 1006, the CPS 402 uses one or more individual preprocessing modules (PPMs) to convert the raw cue information into processed cue information. The outcome of block 1006 represent a vector that has various dimensions corresponding to different cues that may (or may not) be exhibited by a communication session at any particular time. In block 1008, the CPS 402 maps the processed cue information into signal information, which may have one or more dimensions. For example, in the prominent example presented herein, empathy-related signal information has an affiliation dimension and a control dimension. In block 1010, the CPS 402 transforms the signal information into interface information. The interface information may include one or more components devoted to respective dimensions of the signal information. In block 1012, the CPS 402 sends the interface information to one or more output devices, such as a display device. In block 1014, the CPS 402 optionally stores any aspect of the raw cue information, the processed cue information, and/or the signal information. The CPS 402 repeats the procedure 1002 throughout the course of the communication session.

E. Representative Computing Functionality

FIG. 11 sets forth illustrative computing functionality 1100 that can be used to implement any aspect of the functions described above. For example, the type of computing functionality 1100 shown in FIG. 11 can be used to implement the cue processing system 402 of FIG. 4, e.g., using the local functionality shown in FIG. 5, the distributed functionality of FIG. 6, or some other functionality. In one case, the computing functionality 1100 may correspond to any type of computing device that includes one or more processing devices. In all cases, the computing functionality 1100 represents one or more physical and tangible processing mechanisms.

The computing functionality 1100 can include volatile and non-volatile memory, such as RAM 1102 and ROM 1104, as well as one or more processing devices 1106 (e.g., one or more CPUs, and/or one or more GPUs, etc.). The computing functionality 1100 also optionally includes various media devices 1108, such as a hard disk module, an optical disk module, and so forth. The computing functionality 1100 can perform various operations identified above when the processing device(s) 1106 executes instructions that are maintained by memory (e.g., RAM 1102, ROM 1104, or elsewhere).

More generally, instructions and other information can be stored on any computer readable medium 1110, including, but not limited to, static memory storage devices, magnetic storage devices, optical storage devices, and so on. The term computer readable medium also encompasses plural storage devices. In many cases, the computer readable medium 1110 represents some form of physical and tangible entity. The term computer readable medium also encompasses propagated signals, e.g., transmitted or received via physical conduit and/or air or other wireless medium, etc. However, the specific terms “computer readable storage medium” and “computer readable medium device” expressly exclude propagated signals per se, while including all other forms of computer readable media.

The computing functionality 1100 also includes an input/output module 1112 for receiving various inputs (via input devices 1114), and for providing various outputs (via output devices). Illustrative input devices include: a camera device, a depth-determination device, a microphone device, a physiological sensor (or any other kind of medical input device), a keypad input device, a mouse input device, a touchscreen input device, a gesture input device, tabletop or wall-projection input mechanisms, and so on. One particular output mechanism may include a presentation device 1116 and an associated graphical user interface (GUI) 1118. The computing functionality 1100 can also include one or more network interfaces 1120 for exchanging data with other devices via one or more communication conduits 1122. One or more communication buses 1124 communicatively couple the above-described components together.

The communication conduit(s) 1122 can be implemented in any manner, e.g., by a local area network, a wide area network (e.g., the Internet), a point-to-point communication mechanism, etc., or any combination thereof. The communication conduit(s) 1122 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc.

F. Appendix: Illustrative Cues and Signals

As noted in the preceding sections, the signal determination module 414 can produce signal information having various dimensions, e.g., affiliation, control, composure, formality, orientation, etc. This section provides additional details regarding these signals, as well as cues that may be used to produce these signals.

Affiliation refers to a wide set of factors related to interpersonal distance, which affects the immediacy and intimacy of a conversation. For example, the affiliation dimension can include aspects pertaining to warmth, trust, rapport, similarity/depth, and so on. Warmth-related cues pertain to immediacy, affection, closeness, comfort, and positive affect, etc. Trust-related cues pertain to receptivity, sincerity, openness, and disclosure (versus deception), etc. Rapport-related cues pertain to attention, positivity, and coordination, etc. (e.g., the degree to which involvement and respect is expressed). Similarity/depth-related cues pertain to likability, depth of conversation (versus superficiality), mimicry behavior (versus compensatory behavior), etc.

The control dimension includes various factors related to the degree to which power is shared within a communication session. For example, the control dimension can include aspects related to dominance, influence, authority, etc. Dominance-related cues indicate that a participant is taking charge and managing the interaction (as opposed to exercising various forms of submissive behavior). Influence-related cues pertain to persuasiveness, coercion, or capacity to gain the attention or change the behavior of others. Authority-related cues pertain to behavior that is energetic, enthusiastic, charismatic, and/or or arrogant, etc., or behavior that conveys status, expertise, poise, leadership, self-confidence, etc.

The composure dimension refers to the degree to which a participant exhibits calmness or anxiety during the communication session. The formality dimension refers to the degree to which interaction in the communication session can be characterized as formal or relaxed. The orientation dimension refers to the degree to which the interaction focuses on a task at hand (“task orientation”) as opposed to social interaction (“social orientation”).

The signal determination module 414 can use a first model for producing an affiliation relational signal, a second model for producing a control relational signal, a third model for producing a composure relational signal, a fourth model for producing a formality relational signal, and a fifth model for producing an orientation relational signal. As noted in Section B, each model maps a vector associated with the set of cues into an output value. Each model can weight each cue in a different manner that is determined by the training data that is used to produce the model.

More specifically, in some cases, a cue can influence a particular relational signal, such as affiliation. That influence may be positive (+) or negative (−). A positive influence means that an increase in the extent to which a cue is exhibited results in an increase in the relational signal. A negative influence means that an increase in the extent to which a cue is exhibited results in a decrease in the value associated with the signal information. The cue can also have a desirable (↑), undesirable (↓), or neutral ( [symbol] ) effect on the relational signal. A desirable effect means that presence of the cue results in a promotion of whatever goal is being sought, such as increased empathy. An undesirable effect means that the presence of the cue impedes whatever goal is being sought. A neutral effect means that the cue has neither an identifiably desirable nor undesirable effect.

The following listing uses the above-described coding to indicate how the first thirteen cues may map to different dimensions of communication style, and to different aspects of those individual dimensions. For example, the first entry in the list indicates that a first participant has touched a second participant in a social manner. The notation “Affiliation-Warmth (↑+)” means that this cue is desirable in promoting empathy, and an increase in the degree of social touching results in an increase in the affiliation-warmth signal. The notation “Composure (↑, relaxed/calm)” indicates that the presence of this cue is desirable in promoting empathy, and the presence of this cue indicates that the interaction is relaxed and calm at the current time.

However, the training data that is used to produce the models will ultimately determine the manner in which each cue maps to each aspect of the signal information, including the polarity of that influence as well as the strength of the influence. For this reason, the first thirteen cues are annotated in the above-described manner for illustration purposes, not to convey fixed mapping relations. Further the following list of cues is cited by way of illustration, not limitation. In any particular implementation, an administrator can add new cues and/or remove any cues described below.

F.1. Haptic/Touch

(1) Social touch (as when a participant touches another participant in a social context). Affiliation-Warmth (↑ +), Control-Dominance (↓ +), Control-Influence ( [symbol] +), Composure (↑, relaxed/calm), Formality (↓, informal), Orientation (↑, social).

(2) Task touch (as when a participant touches another participant in a task-related context). Affiliation-Rapport (↑ +), Control-Dominance (↓ +), Control-Influence ( [symbol] +), Formality (↑, formal), Orientation (↑, task).

(3) Self-touch by caregiver (as when a caregiver touches her face, rubs her hands together, twists her hair, scratches her body, etc.). Affiliation-Trust (↓ +), Affiliation-Warmth (↑ +), Composure (↓, anxiety/arousal).

(4) Excessive touch (as when a participant engages in excessive touching, according to some standard). Control-Dominance (↓ +), Formality (↑, informal), Orientation (↑, social).

(5) Comfort touch (as when a participant touches another participant in a reassuring manner). Affiliation-Warmth (↑).

(6) Accidental touch (as when a participant accidentally touches another participant). Formality (informal).

(7) Exclamatory touch (as when a participant touches another participant in conjunction with an exclamatory compliment, as in, “you made a clever remark!,” “I'm surprised,” etc.). Affiliation-Rapport (↑), Orientation (↑, social).

(8) Persuasive touch (as when a participant touches another participant in an attempt to influence that person).

(9) Friendly touch (as when a participant touches another participant in a friendly matter, such as to say hello, goodbye, or thanks to that person). Affiliation-Warmth (↑), Orientation (↑, social).

(10) Hug (as when a participant hugs another participant from the front or side, etc.). Affiliation-Trust (↑ +), Affiliation-Warmth (↑ +), Control-Dominance (↑ +), Formality (↑, informal), Orientation (↑, social).

(11) Pat (as when a participant pats another participant on the shoulder or back, etc., e.g., to comfort, to gain attention, etc.). Affiliation-Warmth (↑ +), Control-Influence ( [symbol] +), Formality (↑, informal), Orientation (↑, social).

(12) Touch avoidance (as when a participant appears to be avoiding the touch of another participant). Affiliation-Rapport (↓ −), Affiliation-Trust (↓ −), Affiliation-Warmth (↓ −), Formality ( [symbol] , formal), Orientation ( [symbol] , task).

(13) Touch that distracts (as when a participant touches another participant in a manner that causes distraction). Control-Influence ( [symbol] −), Composure (↓, anxiety/arousal).

F.2. Kinetic/Body

F.2.1 Mouth/Eyes/Brow

(14) Smile (as when a participant smiles to provide positive reinforcement, etc.).

(15) Wide smile.

(16) Open smile (as when a participant shows her teeth while smiling).

(17) Closed smile (as when a participant smiles with her lips closed).

(18) Lip licking.

(19) Lip pursing.

(20) Frown.

F.2.2. Eye-Related

(21) Increased eye contact.

(22) Eye contact while speaking.

(23) Moderate eye contact by the caregiver.

(24) Distancing gaze (as when a participant looks away, possibly avoiding the gaze of another).

(25) Distancing gaze by patient, decreased eye contact by patient.

(26) Direct gaze towards the patient.

(27) Steady, extended gaze (as when a participant glares at another).

(28) Extended mutual gaze.

(29) Shifting gaze (versus steady gaze).

(30) Increased gaze towards the patient.

(31) Increased gaze by the patient.

(32) Widening of eyes.

(33) Closing of eyes.

(34) Squinting of eyes.

(35) Blinking of eyes.

F.2.3. Brow-Related

(36) Raising eyebrow (as when a participant raises an eyebrow and holds it in that position).

(37) Flashing of eyebrow (as when a participant raises and lowers an eyebrow in quick succession).

(38) Lowering of eyebrow.

(39) Furrowing of eyebrow.

(40) Creasing of forehead.

F.2.4. Face

(41) Relaxed facial expression.

(42) Pleasant facial expression (as when a participant attempts to give positive reinforcement to another participant).

(43) Angry facial expression.

(44) Anxious facial expression.

(45) Facial shrug (as when a participant suddenly raises and/or lowers her brow, etc.).

(46) Facial expressivity (as when a participant exhibits expressive facial gestures).

F.2.5. Head

(47) Nodding (as when a participant nods to provide positive reinforcement).

(48) Head shaking (as when a participant shakes her head to signal agreement).

(49) Fluid head turns (as opposed to stiff head turns).

(50) Head tilt.

(51) Head moves up and/or down.

(52) Head turn.

F.2.6. Trunk

(53) Forward lean.

(54) Backward lean.

(55) Sideways lean.

(56) Shoulder shrug.

F.2.7. Hand and Limb

(57) Active gesturing.

(58) Expansive gesturing (as when a participant makes wide gestures to fill the communication space).

(59) Crossed arms.

(60) Arm symmetry (as when a participant maintains her arms in similar orientations, e.g., in side-by-side relation to her body).

(61) Asymmetrical arms/legs (as when a participant maintains her arms in dissimilar orientations, and/or maintains her legs in dissimilar orientations).

(62) Tactile greeting/departure rituals (e.g., when a participant shakes hands or waves goodbye).

F.2.8. Body and Posture

(63) Open arm or body position.

(64) Quick, vigorous movement.

(65) Kinetic expressiveness.

(66) Fluid movement.

(67) Bodily relaxation (as opposed to tense posture and/or nervous movement).

(68) Body shifts.

(69) Body rocking or twisting.

(70) Postural sway.

(71) Open posture.

(72) Erect posture.

(73) Rigid posture (as opposed to a relaxed posture).

(74) Closed body position.

F.3. Proxemics/Spatial

(75) Close proximal distance.

(76) Seeing eye to eye in the same physical plane (as opposed to towering over another).

(77) Direct body orientation (as opposed to giving another an indirect “cold shoulder”).

F.4. Vocal, Non-Content

(78) Speaking in a loud voice (as opposed to a soft voice).

(79) Variation in vocal volume.

(80) Variation in pitch.

(81) Pitch rise.

(82) Increase in pitch.

(83) Increase in intonation.

(84) Variation in tempo.

(85) Increase in tempo.

(86) Moderately fast speech (not slow).

(87) Fast speech.

(88) Fluid speech.

(89) Response latency by the caregiver.

(90) Pause (as when a participant stops talking for various reasons).

(91) Silence (as when a participant fails to give acknowledgement for various reasons).

(92) Vocal activity of the caregiver.

(93) Increased talking time.

(94) Passive voice.

(95) Verbal fluency.

(96) “Friendly” tone of voice (versus cold).

(97) “Angry” tone of voice (which can encourage patient adherence).

(98) Relaxed resonant and rhythmic tone (versus tense voice).

(99) Relaxed laughter.

(100) Sigh.

(101) “Ah huh,” “um-hmm” listener behaviors.

(102) “ah” non-fluencies (“ers,” “ahs,” “ums,” vocalized pauses).

(103) Moderate anxiety in voice (as when a participant appears to be showing concern).

(104) Vocal expressiveness (as when a participant speaks with an animated voice, as opposed to a monotone voice).

F.5. Physiological Cues

(105) Increased heart rate.

(106) Breathiness or increased breathing rate.

(107) Electrodermal activity.

(108) Increase in EMG.

(109) Increase in EEG (or any other brain activity information).

(110) Increase in EKG.

(111) Increase in temperature.

(112) Increase in facial blush and/or tone.

(113) Increase in pulse and/or oxygen in blood.

(114) Amount of airflow in breathing.

(115) Blood sugar (e.g., using a glucometer).

(116) Blood pressure (e.g., using sphygmomanometer).

(117) Position and movement (indicating whether a participant is standing, sitting, supine, prone, or left or right relative to some reference point, etc.).

F.6. Miscellaneous Environmental Cues

(118) Dress (e.g., indicating whether the caregiver is wearing a white coat or other professional attire).

(119) Badge (e.g., indicating whether the caregiver is wearing a badge or other professional indicia).

(120) Hat (indicating whether a participant is wearing a hat).

F.7. Mimicry

(121) Mimicry of cues (as when a participant matches another participant's cues, such as gaze, response latency, orientation, gesture, vocal patterns, posture, etc.).

(122) Coordinated turn-taking (as when two participants match inturn pauses and speech latencies).

(123) Shared talk time.

(124) Interactional synchrony.

(125) Patient mimics posture and relaxation level of caregiver.

F.8. Compensatory

(126) Unsmooth turn taking.

(127) Longer speaking turns by caregiver compared to the patient.

(128) Mismatched lean (as when one participant leans towards another participant, while the other leans away).

(129) Greater response latency of the caregiver compared to the patient.

(130) The caregiver shows more vocal and gestural cues than the patient.

(131) More initiation of interaction by a participant compared to the other participant.

(132) Interruption (as when a participant interrupts the speech of another participant).

(133) Interruption (as when a participant continues to speak when another attempts to interrupt).

(134) Increase in number and length of within-turn silences (as when a participant maintains silence when it is his or her turn to speak).

(135) More pauses by the caregiver while speaking compared to the patient.

(136) Increased patient-caregiver distancing.

(137) Patient does not reciprocate the caregiver's gaze directed at the patient.

(138) Caregiver exhibits more task touch than patients.

(139) Caregiver exhibits more interruptions than patients.

(140) Caregiver pauses more than patient, with less patient speech time.

(141) Height differential between the participants.

F.9. Common Combinations of Cues

(142) Head nodding, with forward lean and open arm position.

(143) Backward lean with crossed arms.

(144) Direct body orientation with arm symmetry.

(145) Smiling with friendly tone of voice.

(146) Smiling, sustained eye contact, nodding, vocal variety, and/or facial expressivity

(147) Close proximal distance, direct face/body orientation, forward lean, increased and direct gaze, frequent gesturing, and positive reinforcement (e.g., by smiling, exhibiting a pleasant facial expression, head nodding, etc.).

(148) Mutual increase in vocal volume and tempo, lowered pitch, more pitch variety, fewer pauses and response latencies, warmer, relaxed resonant and rhythmic voices with frequent relaxed laughter.

(149) Leaning forward, smiling, and nodding, with direct gaze and orientation.

(150) Increased attention through task touch, immediacy cues, and/or vocal variety.

(151) Caregiver exhibits longer speaking turns, more social touch, more pauses while speaking than patients.

(152) Frequent eye contact, vocal variety, smiling, facial pleasantness, and facial expressivity

(153) Maintaining eye contact with affiliation cues (e.g., nodding, smiling, maintaining open arms).

(154) Expansive gestures, facial expressivity, head shaking, wide smile, erect posture, quick/vigorous movement, and fluid movement.

(155) Eyebrow raise, smile, active gesturing, body shifts, fewer eye blinks, and fluid (rather than stiff) head turns.

(156) Lowered brow and lack of smiling.

(157) More caregiver task touch, interruptions, and indirect body position compared to patient.

(158) Lip licking, postural sway, shifting gaze, eye blinks, and speech non-fluencies.

(159) Lack of smile, direct gaze, positive touch, closed stance.

(160) Louder amplitude, more intonation, greater fluency, faster tempo compared to patient.

(161) Consistently high levels of gaze (but not prolonged stare), touch, and close proxemics distancing.

(162) Touch with close proxemics distancing.

(163) Smiling, standing close to someone, looking someone straight in the eye, vocal expressiveness, varied tempo, and loud voice.

(164) Exhibiting speech tempo that is too fast, touch that distracts, and speech non-fluencies.

(165) Patient with passive voice, closed body, and who makes little eye contact.

(166) Patient leaning toward the caregiver, making eye contact, smiling, nodding, exhibiting expressive facial and vocal behavior.

(167) Caregiver interrupts frequently, and talks more than the patient.

(168) Caregiver initiates more nonreciprocal touch, talks more of the time, engages in more interruptions, displays more and longer within-turn silences, produces fewer adaptors than patients.

In closing, the functionality described herein can employ various mechanisms to ensure the privacy of user data maintained by the functionality, if any. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have described various concepts in the context of illustrative challenges or problems. This manner of explanation does not constitute an admission that others have appreciated and/or articulated the challenges or problems in the manner specified herein. Further, the claimed subject matter is not limited to implementations that solve any or all of the noted challenges/problems

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, performed by one or more computing devices, for providing feedback in a context of a communication session among two or more participants, comprising:
receiving raw cue information from one or more input devices, where the raw cue information captures, at least in part, communication behavior exhibited by said two or more communication participants during the communication session;
processing the raw cue information to provide processed cue information;
mapping the processed cue information into signal information, the signal information conveying empathy exhibited during the communication session;
producing interface information that represents the signal information; and
presenting the interface information on one or more output devices for consumption by at least one participant of the communication session.

2. The method of claim 1, wherein the communication session takes place in a healthcare-related environment in which at least one of the participants is a caregiver and at least one of the participants is a recipient of care.

3. The method of claim 1, wherein the communication session takes place in a counseling environment in which at least one of the participants is a counselor and at least one of the participants is a recipient of counseling.

4. The method of claim 1, wherein the communication session takes place in a teaching environment in which at least one of the participants is an instructor and at least one of the participants is recipient of instruction.

5. The method of claim 1, wherein said two or more communication participants comprises more than two participants.

6. The method of claim 1, wherein at least two of said two or more communication participants are physically present in a same physical space.

7. The method of claim 1, wherein at least two of said two or more communication participants are present at different physical locations, and wherein said at least two communication participants communicate via a teleconferencing system.

8. The method of claim 7, wherein said at least two communication participants communicate with each other in a context of a social network system.

9. The method of claim 1, wherein the signal information comprises:
an affiliation dimension which describes a degree to which at least one participant attempts to reduce interpersonal distance with another participant, creating intimacy and immediacy during the communication session; and
a control dimension which describes a degree to which power is distributed among the participants of the communication session.

10. The method of claim 1, wherein the signal information comprises two or more dimensions selected from among:
an affiliation dimension which describes a degree to which at least one participant attempts to reduce interpersonal distance with another participant, creating intimacy and immediacy during the communication session;
a control dimension which describes a degree to which power is distributed among the participants of the communication session;
a composure dimension which describes a degree of anxiety that is exhibited during the communication session, versus calmness;
a formality dimension which describes a degree to which interaction in the communication session is formal in nature, versus relaxed in nature; and
an orientation dimension which describes a degree to which the interaction in the communication session is task-directed in nature, versus social-oriented in nature.

11. The method of claim 1,
wherein the signal information comprises one or more dimensions, and
wherein the interface information includes one or more interface components, each interface component representing a dimension of the signal information.

12. The method of claim 11, wherein each interface component is a separate and independent interface component.

13. The method of claim 11, wherein each interface component corresponds to a sub-component within a high-level interface component.

14. The method of claim 1, wherein the interface information conveys a current instance of signal information, together with one or more previous instances of signal information.

15. The method of claim 1, wherein the interface information includes different components associated with different respective participants of the communication session.

16. The method of claim 1,
wherein the signal information comprises:
an affiliation dimension which describes a degree to which at least one participant attempts to reduce interpersonal distance with another participant, creating intimacy and immediacy during the communication session; and
a control dimension which describes a degree to which power is distributed among the participants of the communication session, and
wherein the interface information conveys the affiliation dimension and the control dimension of empathy using a visual metaphor.

17. The method of claim 16, wherein the visual metaphor is a graphical object having multiple components, wherein:
a subset of the components correspond to a first participant and another subset of the components correspond to a second participant,
a first visual attribute of each component represents the affiliation dimension of the signal information, and
a second visual attribute of each component represents the control dimension of the signal information.

18. The method of claim 17, wherein the graphical object includes a pair of components representing a current instance of signal information, and at least one pair of components representing a prior instance of signal information.

19. One or more computer devices for proving feedback in a context of a communication session among two or more participants, comprising:
a receipt module configured to receive raw cue information from one or more input devices, where the raw cue information captures, at least in part, nonverbal communication behavior exhibited by said two or more participants during the communication session;
a preprocessing module configured to process the raw cue information to provide processed cue information;
a signal determination module configured to map the processed cue information into signal information,
the signal information comprising two or more dimensions, including:
an affiliation dimension which describes a degree to which at least one participant attempts to reduce interpersonal distance with another participant, creating intimacy and immediacy during the communication session; and
a control dimension which describes a degree to which power is distributed among the participants of the communication session.

20. A computer readable storage medium for storing computer readable instructions, the computer readable instructions providing a cue processing system when executed by one or more processing devices, the computer readable instructions comprising:
logic configured to receive raw cue information from one or more input devices, the raw cue information capturing, at least in part, nonverbal communication behavior exhibited by participants of a communication session, and at least one factor pertaining to an environment in which the communication session takes place;
logic configured to process the raw cue information to provide processed cue information;
logic configured to use at least one model to map the processed cue information into signal information, the signal information conveying empathy exhibited during the communication session,
the signal information comprising two or more dimensions selected from among the dimensions of:
an affiliation dimension which describes a degree to which at least one participant attempts to reduce interpersonal distance with another participant, creating intimacy and immediacy during the communication session;
a control dimension which describes a degree to which power is distributed among the participants of the communication session;
a composure dimension which describes a degree of anxiety that is exhibited during the communication session, versus calmness;
a formality dimension which describes a degree to which interaction in the communication session is formal in nature, versus relaxed in nature; and
an orientation dimension which describes a degree to which the interaction in the communication session is task-directed in nature, versus social-oriented in nature; and
logic configured to generate interface information that represents the signal information,
the interface information including two or more interface components, each interface component directed to a dimension of the signal information.
